(19) United States
(12) Patent Application Publication
(10) Pub. No.: US 2011/0043478 A1
(43) Pub. Date: Feb. 24, 2011

(54) PROXIMITY DETECTION DEVICE AND PROXIMITY DETECTION METHOD

(76) Inventor: Kenichi Matsushima, Chiba (JP)

Correspondence Address: Bruce L. Adams;Adams & Wilks, 17 Battery Place, Suite 1231, New York, NY, 10004, US

(21) Appl. No.: 12/735,786

(22) PCT Filed: Jan. 15, 2009
(86) PCT No.: PCT/JP2009/050434

§ 371 Date: Nov. 4, 2010

(30) Foreign Application Priority Data
Feb. 27, 2008 (JP) 2008-046376

(51) Int. Cl. G06F 3/044

(52) U.S. Cl. 345/174

(57) ABSTRACT

In a proximity detection device and a proximity detection method of detecting an approach and a position of an object of a human finger or the like by changes in electrostatic capacitances of respective intersections of plural electrodes arranged in correspondence with two-dimensional coordinates, high-speed detection in a high dynamic range can be performed by low-voltage driving. Alternating voltages having different patterns are simultaneously applied to plural transmitting electrodes, the detected currents are inversely converted by linear computation, and values in response to the electrostatic capacitances of the intersections of the respective electrodes are detected.

### TECHNICAL FIELD

The present invention relates to a proximity detection device of detecting an approach and a position of an object of a human finger or the like by changes in electrostatic capacitances of respective intersections of plural electrodes arranged in correspondence with two-dimensional coordinates.

### BACKGROUND ART

It is known that, when an object of a human finger or the like approaches between closely located two electrodes, the electrostatic capacitance between the electrodes changes. Proximity detection devices such as an electrostatic touch sensor to which the principle is applied to the detection of the electrostatic capacitances of respective intersections of plural electrodes arranged in correspondence with two-dimensional coordinates in a detection area have been disclosed and some of them have been put into practical use (for example, see Patent Documents 1 and 2).

An example of the conventional proximity detection device will be explained based on FIG. 2.

In the example of FIG. 2, in a detection area 2 of supporting means 1, transmitting electrodes 3 corresponding to longitudinal coordinates and receiving electrodes 4 corresponding to lateral coordinates are arranged orthogonally to each other. To the transmitting electrodes 3, a periodic alternating voltage is selectively applied with respect to each electrode (line-sequential driving) from a line-sequential driving means 35. The alternating voltage is transmitted to the receiving electrode 4 by the electrostatic coupling of the intersection between the transmitting electrode 3 and the receiving electrode 4. In current measurement means 6, values responding to the electrostatic couplings of the respective corresponding intersections from currents flowing in the virtually grounded receiving electrodes 4 are detected, and the detected values are output to proximity computing means 8. Here, in order to accumulate and obtain weak alternating currents, methods of switching accumulation capacitors in synchronization with periodic alternating voltages sequentially and selectively applied to the transmitting electrodes 3 and accumulating the currents by convolving demodulated waveforms have been disclosed.

The proximity computing means 8 obtains the approach and the position of the object as a target of detection from the values in response to the electrostatic capacitances of the respective intersections of the electrodes corresponding to the two-dimensional coordinates and their changes.

Patent Document 1: JP-T-2003-526831

Patent Document 2: US2007/0257890 A1

### DISCLOSURE OF THE INVENTION

### Problems that the Invention is to Solve

In the above described conventional proximity detection device, the transmitting electrodes have been selected one by one and sequentially driven by line-sequential driving. In order to make the influence of the noise on the receiving electrodes relatively smaller, it has been necessary to increase the number of cycles of the alternating voltages and raising the voltages for driving the transmitting electrodes. For the purpose, the number of cycles of the alternating voltages, i.e., the detection speed and the voltage for driving the transmitting electrodes have been problematic.

Accordingly, in the invention, there is provided a device and method as below are provided to solve these problems a proximity detection device and method that can suppress the influence of the noise even when the device is driven at a relatively low voltage and detection is performed at a high speed by simultaneously applying alternating voltages to plural transmitting electrodes.

### Means for Solving the Problems

A proximity detection device according to the invention includes plural transmitting electrodes corresponding to one dimension of two-dimensional coordinates in a detection area on supporting means and receiving electrodes corresponding to the other dimension provided via insulating layers for preventing electric continuity between them, multiline driving means for simultaneously applying periodic alternating voltages to the plural electrodes of the transmitting electrodes, current measurement means for measuring magnitude of currents from the receiving electrodes that change in response to electrostatic couplings of the intersections between the transmitting electrodes and the receiving electrodes in synchronization with driving to the transmitting electrodes, computing means for obtaining an approach determination and an approach position of an object toward the detection area by values obtained by converting current values measured in the current measurement means into values in response to electrostatic capacitances of the respective intersections between the transmitting electrodes and the receiving electrodes and their transition, and control means for managing the entire statuses and sequences.

Further, a proximity detection method according to the invention includes a driving and measurement step of repeatedly performing measurement of the currents from the receiving electrodes using the current measurement means while simultaneous application of periodic alternating voltages to plural electrodes by the multiline driving means with various combinations of the transmitting electrodes and the alternating voltages, a computation step of obtaining the approach determination and the approach position of the object toward the detection area using the proximity computing means from values obtained by converting measurement values obtained at the driving and measurement step into values in response to electrostatic capacitances of the respective intersections by linear computation using the linear computing means or their transition.

### Advantages of the Invention

According to the invention, a proximity detection device and method that can successfully perform detection by simultaneously applying alternating voltages to plural transmitting electrodes even when driving at a relatively low voltage or operating at a high speed can be realized. When power supply voltage, the detection speed, and the frequencies of the alternating voltages are the same, a proximity detection device and method that can make the influence of noise smaller can be realized.

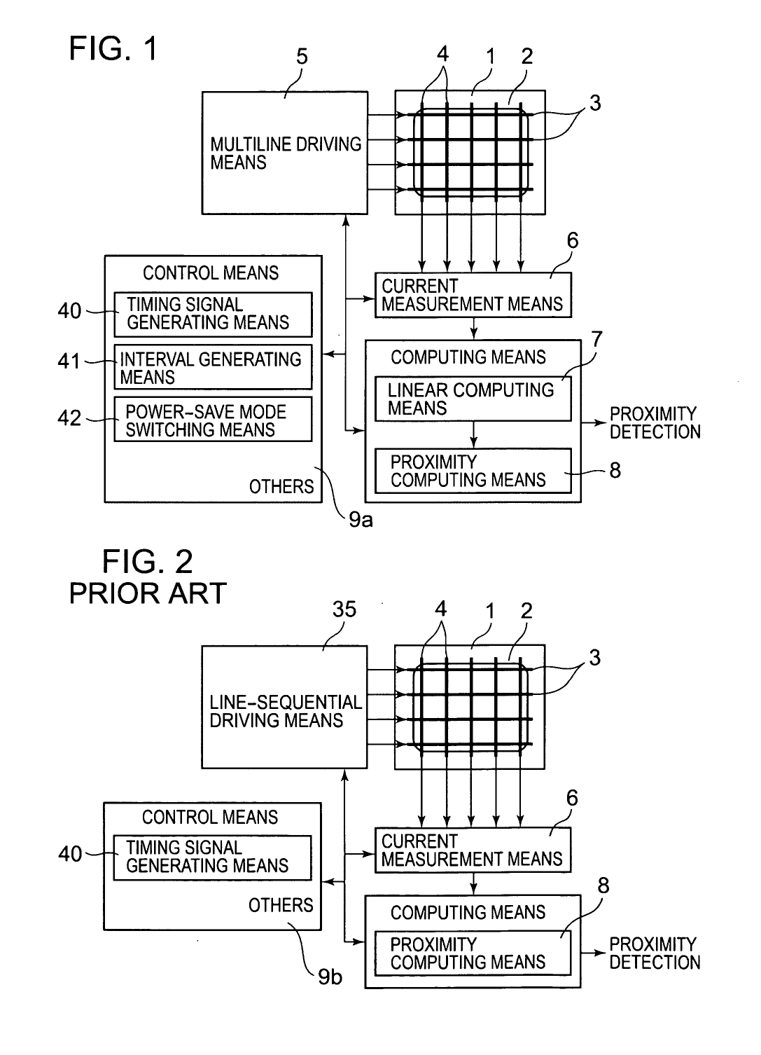

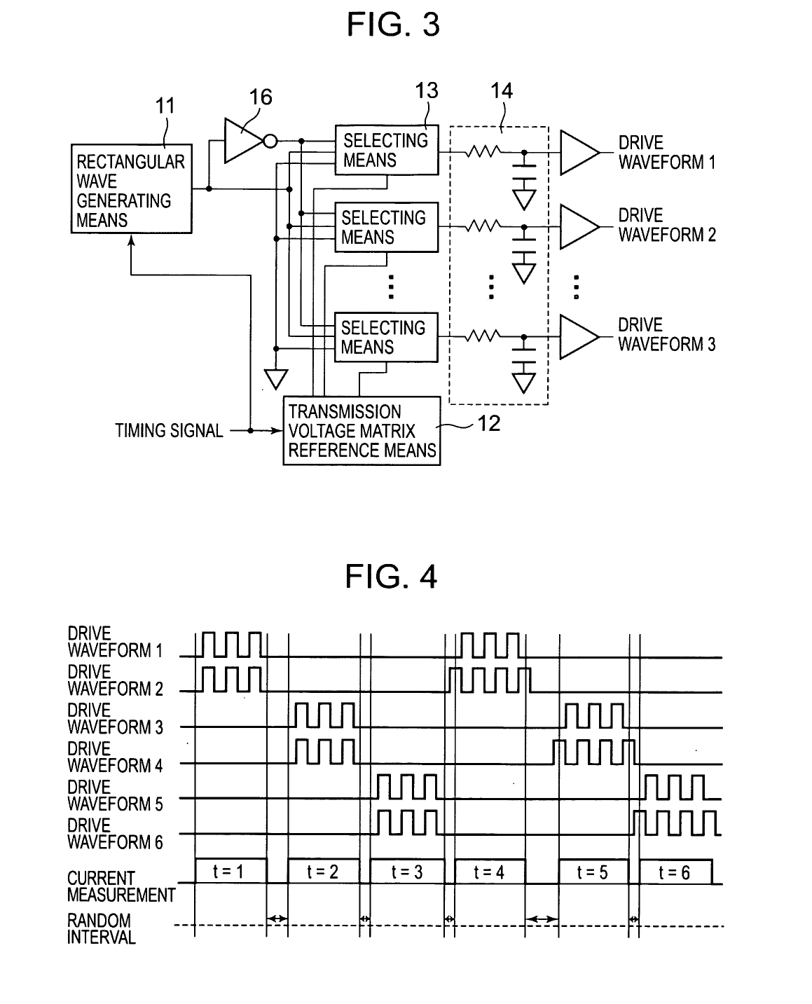

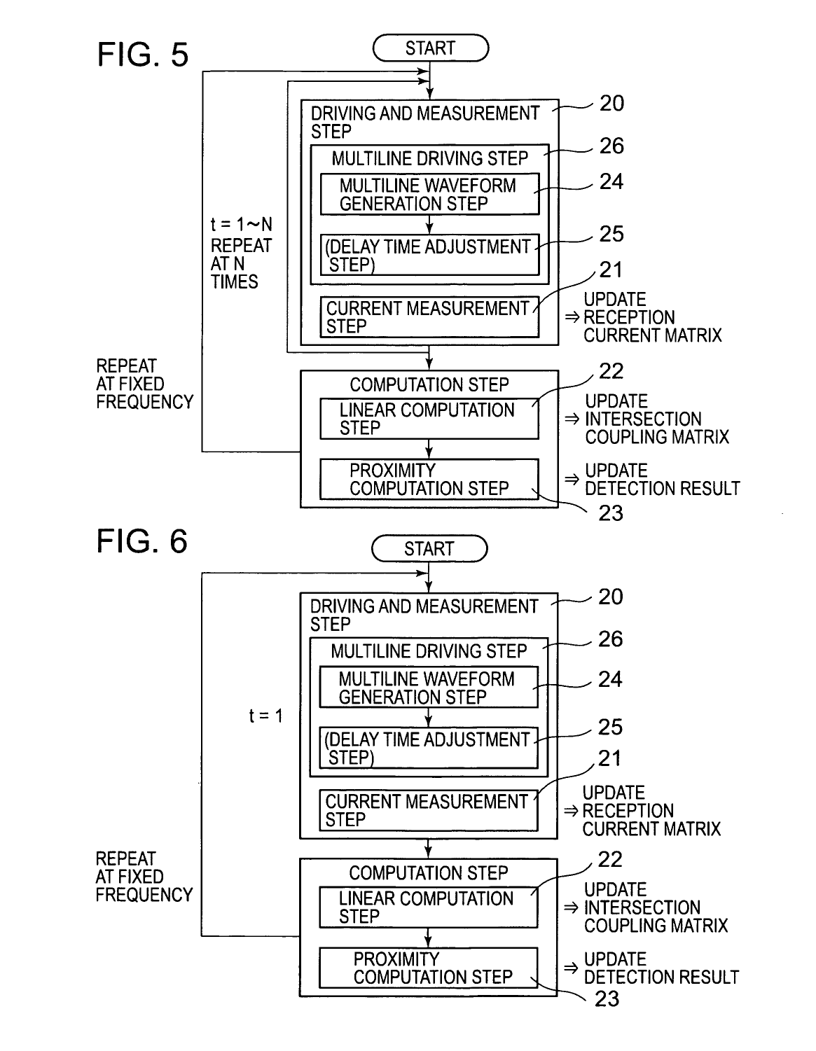

### BRIEF DESCRIPTION OF THE DRAWINGS

[FIG. 1] A block diagram showing one preferred embodiment of a proximity detection device according to the invention.

[FIG. 2] A block diagram showing a conventional proximity detection device.

[FIG. 3] A block diagram showing an embodiment of multiline driving means according to the invention.

[FIG. 4] A timing chart of a driving and measurement step according to the invention.

[FIG. 5] A process flow chart of a proximity detection method according to the invention.

[FIG. 6] Another process flow chart of the proximity detection method according to the invention.

### DESCRIPTION OF REFERENCE NUMERALS AND SIGNS

1 supporting means
2 detection area
3 transmitting electrode
4 receiving electrode
5 multiline driving means
6 current measurement means
7 linear computing means
8 proximity computing means
9a control means
9b control means (conventional example)
11 rectangular wave generating means
12 transmission voltage matrix reference means
13 selecting means
14 delay time adjustment means
16 inverter
20 driving and measurement step
21 current measurement step
22 linear computation step
23 proximity computation step
24 multiline waveform generation step
25 delay time adjustment step
26 multiline driving step
35 line-sequential driving means (conventional example)
40 timing signal generating means
41 interval generating means
42 power-save mode switching means

### BEST MODE FOR CARRYING OUT THE INVENTION

### Embodiment

A preferred embodiment of the invention will be explained based on FIG. 1.

A proximity detection device according to the invention includes, in FIG. 1, transmitting electrodes 3 corresponding to one dimension of two dimensional coordinates in a detection area 2 on supporting means 1 and receiving electrodes 4 corresponding to the other dimension provided via insulating layers for preventing electric continuity between them, multiline driving means 5 for simultaneously applying periodic alternating voltages to plural electrodes of the transmitting electrodes 3, current measurement means 6 for measuring the magnitudes of the currents from the receiving electrodes 4 that change in response to the electrostatic couplings of the intersections between the transmitting electrodes 3 and the receiving electrodes 4 in synchronization with the driving to the transmitting electrodes 3, computing means for obtaining an approach determination and an approach position of an object toward the detection area 2 by values obtained by converting current values measured in the current measurement means 6 into values in response to the electrostatic capacitances of the respective intersections between the transmitting electrodes 3 and the receiving electrodes 4 and their transition, and control means 9a for managing the entire statuses and sequences. The computing means includes linear computing means 7 for converting the current values measured in the current measurement means 6 into the values in response to the electrostatic capacitances of the respective intersections between the transmitting electrodes 3 and the receiving electrodes 4, and proximity computing means 8 for obtaining the approach determination and the approach position of the object toward the detection area 2 by the values in response to the electrostatic capacitances of the respective intersections from the linear computing means 7 or their transition.

The features of the invention will be explained based on the differences from the conventional example.
(1) Difference in driving means (step). The conventional line-sequential driving means 35 is replaced by the multiline driving means 5 of the invention. Conventionally, a periodic alternating voltage is selectively applied with respect to each electrode (line-sequentially) for driving, however, in the invention, there is a difference in that periodic alternating voltages are simultaneously applied to the plural electrodes of the transmitting electrodes. Accordingly, the structure of the driving means is different. At the driving step, there is a difference in that the line-sequential driving conventional step is replaced by a multiline driving step 26.
(2) Addition of the linear computing means 7 and a linear computation step 22. Conventionally, the current values measured in the current measurement means 6 are just output to the proximity computing means 8. In the invention, not the conventional line-sequential driving, but multiline driving is employed, and therefore, the linear computing means 7 for converting the current values measured in the current measurement means 6 into the values in response to the electrostatic capacitances of the respective intersections between the transmitting electrodes 3 and the receiving electrodes 4 is added. Then, the values are output to the proximity computing means 8. Since the invention employs the multiline driving, the values are simultaneously output from the plural intersections. By adding means for conversion into values respectively corresponding to the respective intersections between the current measurement means 6 and the proximity computing means 8, detection using multiline driving is realized. Similarly, the invention is also different from the conventional example in the process that the linear computation step 22 is added between a current measurement step 21 and a proximity computation step 23.
(3) Addition of interval generating means 41 for providing random intervals to the control means 9a. In the invention, for the purpose of making the influence of noise random, random intervals are inserted between output times from the transmitting electrodes 3 according to need. Thereby, the influence of noise may be made random in the multiline driving.
(4) Addition of power-save mode switching means 42 to the control means 9a. In the invention, because of the multiline driving, to accurately obtain the approach position of a finger, it is necessary to drive the respective transmitting electrodes 3 at the same number of times as the number of the transmitting electrodes 3 as measurement for one period. However, in the case where it is not necessary to know the accurate approach position such that the target of detection of a human finger or the like does not approach the detection area 2, suppression of power consumption can be realized by driving the respective transmitting electrodes 3 in the smaller number of times than the number of transmitting electrodes 3 as measurement for one period. Accordingly, the presence or absence of the approach of the target of detection such as a finger is determined (approach determination) by the proximity computing means 8, if the target of detection such as a finger does not approach, the mode is switched to a mode of driving the respective transmitting electrodes 3 in the smaller number of times than the number of transmitting electrodes 3 in measurement for one period (power-save mode), and, if the target of detection such as a finger approaches, the mode is switched to a mode of driving the respective transmitting electrodes 3 in the same number of times as the number of transmitting electrodes 3 in measurement for one period by the power-save mode switching means 42. In the above described power-save mode, suppression of power consumption can be expected if the electrodes are driven in the smaller number of times than the number of the respective transmitting electrodes 3, and the case of single driving may be the most preferable. In this case, the detected position of the detection area 2 is not located, however, information on the presence or absence of detection in the whole detection area 2 can be obtained. When the target of detection such as a finger is detected in the power-save mode, the power consumption may be suppressed by switching the mode from the power-save mode to the mode of driving the respective transmitting electrodes 3 in the number of transmitting electrodes 3 in measurement for one period.

As below, the respective means and the respective steps forming the proximity detection device and method according to the invention will be explained in detail.

In the detection area 2 of the supporting means 1, for example, the transmitting electrodes 3 corresponding to the longitudinal coordinates and the receiving electrodes 4 corresponding to the lateral coordinates are arranged orthogonally to each other. However, the arrangement of the transmitting electrodes 3 and the receiving electrodes 4 is not limited to that, but any arrangement may be employed as long as the electrodes correspond to two dimensional coordinates such as oblique coordinates and circular polar coordinates of angles and distances from the origin. These electrodes are conductive and both electrodes are galvanically isolated by the insulating layers at the intersections between the transmitting electrodes 3 and the receiving electrodes 4 and electrically and electrostatically coupled.

Here, for convenience of explanation, the transmitting electrode 3 is present with respect to each corresponding position represented by coordinate values of natural numbers from 1 to N, and the corresponding transmitting electrodes 3 are discriminated by the indexes n. Similarly, the receiving electrode 4 is present with respect to each corresponding position represented by coordinate values of natural numbers from 1 to M, and the corresponding transmitting electrodes 4 are discriminated by the indexes m.

The multiline driving means 5 applies the periodic alternating voltages corresponding to a transmission voltage matrix T(t,n) to the plural transmitting electrodes 3. The index t of the transmission voltage matrix T is a row number of the matrix corresponding to tth driving, and the index n is a column number corresponding to the nth transmitting electrode 3. That is, the alternating voltage applied to the transmitting electrode 3 in the second driving corresponds to T(2,3).

The simultaneously applied plural alternating voltage waveforms are plural alternating voltage waveforms obtained by multiplying a certain identical alternating voltage waveform by respectively corresponding elements T(t,n) of the transmission voltage matrix as factors. Therefore, in the case where the elements of the transmission voltage matrix are negative, that means application of alternating voltage waveforms in reversed phase. In this regard, if the direct-current components are superimposed, they have no influence.

Here, the transmission voltage matrix T(t, n) is a regular matrix as a square matrix having an inverse matrix. Accordingly, the index t is a natural number from 1 to the number of transmitting electrodes N. In the case of the conventional line-sequential driving, the transmission voltage matrix T(t,n) is identical with the unit matrix I(t,n).

Further, the periodic alternating voltage has rectangular wave, sin wave, or triangular wave, for example. Note that, since the respective electrodes themselves have resistance values and electrostatic capacitances, the high frequencies attenuate, and, at the intersections, the low frequencies attenuate due to the electrostatic capacitances in series. In view of the facts, it is desirable to set the frequencies of the voltages applied to the transmitting electrodes 3 to frequencies with low attenuation.

To further simplify the configuration, for example, using a regular matrix as the transmission voltage matrix T(t,n) by setting the respective elements to “1”, “0”, or “-1” such that the absolute values of the respective elements except “0” may be the same value, and using rectangular waves as the periodic alternating voltages, for example, the multiline driving means 5 can be formed with a simple logical circuit as shown in FIG. 3.

Here, the configuration in FIG. 3 will be explained. The timing signals corresponding to the row number t of the transmission voltage matrix are output from timing signal generating means 40 within the control means 9a in FIG. 1 to transmission voltage matrix reference means 12 in FIG. 3, and the timing signals for generating rectangular waves in synchronization are output to rectangular wave generating means 11. The rectangular wave generating means 11 generates plural cycles of rectangular waves based on the above described timing signals, and is connected to N pieces of selecting means 13 using two kinds of wires of a wire via an inverter 16 and a wire not via the inverter 16. The selecting means 13 selects the wire not via the inverter 16 if the values of the corresponding elements of the transmission voltage matrix are “1”, selects the wire via the inverter 16 if the values of the corresponding elements of the transmission voltage matrix are “−1”, and selects a wire of 0 V if the values of the corresponding elements of the transmission voltage matrix are “0”. The signal selected by the selecting means 16 passes through delay time adjustment means 14 according to need, and is output as a drive waveform. A resistor is series-connected to the above described delay time adjustment means 14, and the other terminal of a capacitor connected to a constant-voltage power supply is connected via the resistor. At the output of the delay time adjustment means 14, a buffer may be provided according to need for lowering the impedance.

If a certain element of the transmission voltage matrix T(t,n) to the transmission voltage matrix reference means 12 is “0”, in order to make the alternating voltage waveform corresponding to the element, 0 V is connected to the transmitting electrode 3 by the selecting means 13, for example. If the element of the transmission voltage matrix T(t,n) is “1”, the wire not via the inverter 16 is selected by the selecting means 13 in the rectangular wave generating means 11. If the element of the transmission voltage matrix T(t,n) is “−1”, the wire via the inverter 16 is selected by the selecting means 13 in the rectangular wave generating means 11. In this manner, the operation is performed according to the element of the transmission voltage matrix T(t,n).

Note that, since the receiving electrodes 4 in FIG. 1 themselves have resistance values and electrostatic capacitances, delay times are produced for transmission of alternating voltages. In FIG. 3, the delay time adjustment means 14 at the downstream of the selecting means 13 is for fine adjustment of the times, and provided according to need. This is for fine adjustment of the delay times to the receiving electrodes 4 different depending on the transmitting electrodes 3. That is, for adjustment to the farther transmitting electrodes 3 from the current measurement means 6, the delay times for the nearer transmitting electrodes 3 are set longer. Thereby, it is expected that the influence by variations in delay times produced to the receiving electrodes 4 is eliminated and transmitted to the current measurement means 6 at the same time.

The periodic alternating voltage applied to the nth transmitting electrode 3 is transmitted to the mth receiving electrode 4 via the electrostatic coupling at the intersection between the nth transmitting electrode 3 and the mth receiving electrode 4. If there is an influence of contamination on the detection surface or the like, because the impedance of the approaching object itself is high, the electric field between the transmitting electrode 3 and the receiving electrode 4 increases due to the electric field via the approaching object, the electrostatic coupling between the transmitting electrode 3 and the receiving electrode 4 increases, and the reception current flowing in the receiving electrode 4 becomes larger. On the other hand, in the case where an object with relatively low impedance such as a human finger as a target of detection approaches, because the action of absorbing the alternating electric field from the transmitting electrode 3 is stronger, the electrostatic coupling between the transmitting electrode 3 and the receiving electrode 4 decreases, and the reception current flowing in the receiving electrode 4 becomes smaller. Therefore, the targets of detection of the contamination and the human finger can easily be discriminated.

Here, the receiving electrode 4 is suppressed in voltage variations by grounding or virtual grounding so that there is no influence even when an object approaches other parts than around the intersection for the target of detection. Accordingly, the transmission to the receiving electrode 4 is a current not a voltage. That is, since the alternating electric field is generated by the electrostatic coupling at the intersection between the selected transmitting electrode 3 and a certain receiving electrode 4, a reception current flows in the receiving electrode 4. Therefore, at the intersection where the object approaches, the alternating electric field changes and the reception current flowing in the receiving electrode 4 changes.

In the current measurement means 6, at each time when the alternating voltage waveform corresponding to the transmission voltage matrix T(t,n) is applied to the transmitting electrode 3 by the multiline driving means 5, the reception current flowing in the mth receiving electrode 4 is measured, converted into a digital value by a delta-sigma type AD converter or the like, for example, and the corresponding value of a reception current matrix R(t,m) is updated and output to the linear computing means 7. The index t here is a row number of the matrix indicating a current by the tth driving in the multiline driving means 5, and the index m is a column number corresponding to the number of receiving electrode 4.

Here, the values of the electrostatic capacitances of the respective intersections are typically small values of about 1 pF, and the reception currents flowing in the receiving electrodes 4 and their changes are weak. Accordingly, for detection of the reception currents flowing in the receiving electrodes 4, currents in plural periods applied from the transmitting electrodes 3 are accumulated and detected. However, since the reception currents flowing in the receiving electrodes 4 are alternating currents, if they are simply accumulated, an accumulated value becomes zero. To avoid this, the same method as that in the case of the conventional line-sequential driving can be used. That is, accumulation in synchronization with the phases of the alternating currents is performed. For example, the method of switching accumulation capacitors in synchronization with the periodic alternating voltages applied to the transmitting electrodes 3 has been disclosed in Patent Document 1 and the method of accumulating the currents by convolving demodulated waveforms in synchronization with periodic alternating voltages applied to the transmitting electrodes 3 has been disclosed in Patent Document 2. Note that, depending on the values of the transmission voltage matrix, the received current values may be negative values. Also, in this case, it is necessary to make consideration so that the reception circuit may not be saturated. As a specific method, for example, the reference voltage and power supply voltage in the linear computing means 7 are set and adjusted to the values not to be saturated.

Further, in the current measurement means 6, by subtraction of a value near the measurement value when the object as the target of detection does not approach as an offset, the change of the measurement value by the approach of the object can be measured more accurately. In this regard, the measurement value when the object as the target of detection does not approach is largely affected by the transmission voltage matrix T(t,n). Accordingly, subtraction of values different depending on the indexes t as offsets is performed. Furthermore, in the case where there is an influence of a contamination on the detection surface or the like, subtraction of values different depending on the mth receiving electrode 4 may be performed.

The values of the reception current matrix R(t,m) measured when multiline driving is performed are expressed by a matrix product of the transmission voltage matrix T(t, n) and an intersection coupling matrix P(n,m) as shown in Formula 1. Here, the intersection coupling matrix P(n,m) responds to the strengths of the electrostatic couplings of the respective intersections of the electrodes corresponding to the two-dimensional coordinates, and provides an assumption of values of the reception current matrix that would be obtained if the transmission voltage matrix of the unit matrix performs line-sequential driving. Note that the index n here is a row number of the matrix corresponding to the nth transmitting electrode 3, and the index m is a column number corresponding to the mth receiving electrode 4.

R(t,m)=T(t,n)P(n,m) Formula 1

This is because the currents by the electrostatic couplings are linear and the addition theorem holds. For example, it is assumed that the reception current flowing into the mth receiving electrode 4 when an alternating voltage of 1 V is applied to the n1th transmitting electrode 3 is R(n1,m) and the reception current flowing into the mth receiving electrode 4 when an alternating voltage of 1 V is applied to the n2th transmitting electrode 3 is R(n2,m). When an alternating voltage of 2 V is applied to the n1th transmitting electrode 3 and an alternating voltage of 3 V is applied to the n2th transmitting electrode 3 at the same time, the current as a sum of R(n1,m) multiplied by a factor of “2” and R(n2,m) multiplied by a factor of “3” flows in the mth receiving electrode 4.

Therefore, in the linear computing means 7, as shown by Formula 2, the reception current matrix R(t,m) from the current measurement means 6 is multiplied by an inverse matrix of the transmission voltage matrix T(t,n) from the left. Thereby, the matrix is converted into the intersection coupling matrix P(n,m) that would flow if the line-sequential driving is performed. Since the transmission voltage matrix is a regular matrix, the inverse matrix must exist. Formula 2 is obtained by multiplying both sides of Formula 1 by the inverse matrix of the transmission voltage matrix T(t,n) from the left and exchanging the right side and the left side.

P(n,m)={Inverse Matrix of T(t,n)}R(t,m) Formula 2

Note that the inverse matrix of the transmission voltage matrix T(t,n) here may not necessarily be calculated in each case, but typically, the inverse matrix calculated in advance may be used.

Further, in the computation of the linear computing means 7, multiplication of matrices is not necessarily performed. Computation is not necessary for the term in which the values of the elements of the inverse matrix of the transmission voltage matrix T(t,n) become “0”, and simple addition and subtraction may be performed when the values of the elements are obtained by multiplication of “1” or “−1” by the same factor. That is, the computation of Formula 2 may be performed after all elements of the inverse matrix of the transmission voltage matrix T(t,n) are multiplied by the same factor. In this manner, all of the decimal elements are turned into integer numbers and the computation becomes easier. Especially, in the case where the absolute values of all elements except “0” are the same decimals, all elements are turned into “1”, “0”, or “−1” by factor multiplication and only simple addition and subtraction may be performed. In the proximity computing means 8, proximity computation is performed not with absolute values but with relative values and the factor multiplication is characterized by hardly affecting the computation result. Accordingly, the factor multiplication of the respective elements into integer numbers is effective.

The proximity computing means 8 calculates the approach and the position of the object as the target of detection from the intersection coupling matrix P(n,m) that would flow when the line-sequential driving is performed as current values depending on the electrostatic couplings of the respective intersections of the electrodes corresponding to the two-dimensional coordinates obtained in the linear computing means 7 and their transition.

The control means 9a manages the statuses and the sequences of the entire operation. The status here refers to statuses of during current measurement or the like, for example, and the sequence refers to procedures of ON and OFF of the current measurement. The control means 9a includes timing signal generating means 40, interval generating means 41, and power-save mode switching means 42. Note that the interval generating means 41 and the power-save mode switching means 42 are added according to need.

A specific operation example using the proximity detection method according to the invention will be explained based on FIG. 5. This is an example of the case where driving and measurement for N rows of the transmission voltage matrix are collectively performed at a driving and measurement step 20 and then computation is performed at a computation step. The proximity detection method is started, and, at the driving and measurement step 20, driving is performed, currents are measured, and the reception current matrix is updated. For the purpose, the driving and measurement step 20 includes a multiline driving step 26 and a current measurement step 21 for measurement of reception currents. The multiline driving step 26 and the current measurement step 21 are performed nearly at the same time. Further, the multiline driving step 26 has a multiline waveform generation step 24 and a delay time adjustment step 25 according to need. By repeating update of the reception current matrix at N times of t=1 to N, a series of driving corresponding to all elements of the transmission voltage matrix is performed. Then, the computation step is performed. The computation step includes a linear computation step 22 and a proximity computation step 23. Linear computation is performed on the reception current matrix updated at the driving and measurement step 20 by the linear computation step 22, and the intersection coupling matrix is updated. Then, the approach and the position of the object as the target of detection is detected from values of the intersection coupling matrix updated at the linear computation step 22 by the proximity computation step 23 or their transition. By repeating the series of steps at a fixed frequency, the proximity detection method is realized. Note that this is an example and, during the linear computation step 22 and the proximity computation step 23, the next driving and measurement step 20 may be simultaneously performed by parallel processing or the like, for example.

In this manner, at the driving and measurement step 20, currents of the receiving electrodes 4 are measured at the current measurement step 21 while driving to the transmitting electrodes 3 is performed by the multiline driving step 26, and converted into digital values. In this regard, by repetition at N times while the number of times t of normal driving is from “1” to N, the series of driving corresponding to all elements in the transmission voltage matrix is performed.

FIG. 4 shows a more detailed specific timing chart of the driving to the transmitting electrodes 3 and current measurement from the receiving electrodes 4.

In FIG. 4, drive waveforms show voltage waveforms of the respective transmitting electrodes 3, and, regarding the current measurement, timing of measuring alternating currents corresponding to the drive waveforms is shown. The random interval refers to insertion of random waiting times for making the influence of noise random, and arbitrary intervals may be inserted according to need between plural times of measurement of currents corresponding to the transmitting electrodes 3, for example. The horizontal axis is a time axis common to them. FIG. 4 shows six waveforms of drive waveform 1 to drive waveform 6 for convenience sake, however, this is schematic and the number of drive waveforms is N. For example, when current measurement is t=4 with drive waveform 1 and drive waveform 2, the drive waveform 1 applies 3 cycles of rectangular waves starting from rising and the drive waveform 2 applies 3 cycles of rectangular waves starting from falling with reversed polarity. Further, regarding the state of the current measurement t=5 of drive waveform 4 and the current measurement t=6 of drive waveform 6, 3 cycles of rectangular waves starting from falling with reversed polarity are applied, and, for other states, 3 cycles of rectangular waves starting from rising are applied. Their polarities respond to values of the respective elements of the transmission voltage matrix.

The timing in FIG. 4 is an example of the case where the matrix T expressed in Formula 11, which will be described later, as the transmission voltage matrix, and drive waveforms are sequentially applied to the respective transmitting electrodes 3 with polarities based on the values of the transmission voltage matrix. In the schematic chart, application of rectangular waves in one driving is performed in 3 cycles for convenience sake, however, it is obvious that the application is not limited to that. Note that driving to the transmitting electrodes 3 and current measurement of alternating currents from the receiving electrodes 4 are synchronized as is the case of the conventional line-sequential driving 35, and the current measurement values by the reversed driving are reversed in sign. The values of the reception current matrix are updated by the currents measured by the driving. By performing the series of driving corresponding to all elements of the transmission voltage matrix, all elements of the reception current matrix are also updated.

At the linear computation step 22, linear computation is performed on the reception current matrix updated at the current measurement step 21 by the linear computing means 7, and the values of the intersection coupling matrix are updated.

At the proximity computation step 23, the approach and the position of the object as the target of detection are detected by the proximity computing means 8 from the values of the intersection coupling matrix updated at the linear computation step 22 or their transition.

Note that, in the case where the object as the target of detection has not approached yet and accurate position computation is not necessary, it is not necessarily required that driving to the transmitting electrodes 3 and the current measurement from the receiving electrodes 4 are performed with respect to all rows of the transmission voltage matrix. At the minimum, driving may be performed only on the rows of the transmission voltage matrix for driving all transmitting electrodes 3. In other words, driving may be performed on each column at least once. For example, in the case of using the transmission voltage matrix T shown in the above described Formula 11, all transmitting electrodes 3 are driven by performing driving only on the rows corresponding to t=1 to 3, and, in the case of using the transmission voltage matrix T shown in Formula 9, only one of the rows maybe driven. That is, driving is performed at the smaller number of times of driving than the number of transmitting electrodes 3. In this case, it is only necessary to extract changes, and the linear computation step 22 may be omitted. The approach of the object can be detected by the proximity computing means 8 if the object approaches any intersection, because there are usually some changes in the values of the reception current matrix. In this manner, the power consumption in waiting for the approach of the object can be made lower. This is the so-called power save. For example, in the case where all transmitting electrodes 3 are simultaneously driven, which will be described later, as shown in FIG. 6, it may be possible to only perform driving to the transmitting electrodes 3 and the current measurement from the receiving electrodes 4 with respect to one row of the transmission voltage matrix. Further, in the case of the transmission voltage matrix T shown in Formula 11, all transmitting electrodes 3 are driven by driving of the first three rows.

The procedures shown in FIG. 6 will be explained. In FIG. 6, there are nearly the same steps as those in FIG. 5. The difference is in the number of times of driving and measurement at the driving and measurement step 20. In this proximity detection method, for example, at each time when driving and measurement for one row of the transmission voltage matrix are performed, linear computation and proximity computation are performed based on the updated reception current matrix, and the operation is repeated in a fixed frequency. Thereby, the power-save mode is realized.

As above, the explanation has been made based on Formula 1 and Formula 2, however, it is obvious that the sequence of multiplication of the matrices using transposed matrices of the transmission voltage matrix T(t,n), the intersection coupling matrix P(n,m), and the reception current matrix R(t,m) may achieve the same result. In this case, Formula 3 corresponds to Formula 1 and Formula 4 corresponds to Formula 2. The calculation processing is performed at the linear computation step 22 by the linear computing means 7.

R^{T}(m,t)=P^{T}(m,n)T^{T}(n,t) Formula 3

P^{T}(m,n)=R^{T}(m,t){Inverse Matrix of T^{T}(n,t)} Formula 4

Note that, as above, the example of the case where the alternating currents in response to the alternating voltage waveforms of the transmitting electrodes 3 and the electrostatic capacitances of the intersections between the transmitting electrodes 3 and the receiving electrodes 4 are measured in the current measurement means 6 has been shown, however, in the current measurement means 6, values in response to the amounts of charge flowing in proportion to the electrostatic capacitances of the intersections between the transmitting electrodes 3 and the receiving electrodes 4 when the step-like voltage changes are applied to the transmitting electrodes 3 may be measured. In this case, given that the voltage change including polarity of the nth transmitting electrode 3 is V(t,n) corresponding to the transmission voltage matrix T(t,n), the electrostatic capacitance of the intersection between the nth transmitting electrode 3 and the mth receiving electrode 4 corresponding to the intersection coupling matrix P(n,m) is C(n,m), the amount of charge flowing in the mth receiving electrode 4 corresponding to the reception current matrix R(t,m) measured in the current measurement means is Q(t,m), and the number of times of the voltage change of the transmitting electrode 3 for measurement of the amount of charge is “1”, Formula 5 and Formula 6 hold. Formula 6 is used for conversion into the electrostatic capacitances of the intersections corresponding to the intersection coupling matrix by the linear computing means 7 and the linear computation step 22.

Q(t,m)=1·V(t,n)C(n,m) Formula 5

C(n,m)={Inverse Matrix of V(t,n)}Q(t,m)/1 Formula 6

These Formula 5 and Formula 6 correspond to Formula 1 and Formula 2. Further, regarding Formula 5 and Formula 6, as shown in Formula 7 and Formula 8, it is obvious that the sequence of multiplication of the matrices using transposed matrices may achieve the same result.

Q^{T}(m,t)=1·C^{T}(m,n)V^{T}(n,t) Formula 7

C^{T}(m,n)=Q^{T}(m,t){Inverse Matrix of V^{T}(n,t)}/1 Formula 8

As below, relationships between the respective elements of the transmission voltage matrix T(t,n) and effects as a feature of the invention will be explained. As described above, it is necessary that the transmission voltage matrix is a regular matrix having an inverse matrix. Further, it is desirable that the values of the elements of the transmission voltage matrix T(t,n) are obtained by multiplication of “1”, “0”, or “−1” by the same factor for the simpler drive circuit. Furthermore, for simpler linear computation, it is desirable that the elements of the inverse matrix are integer numbers multiplied by the same factor, specifically, “1”, “0”, or “−1” multiplied by the same factor. In addition, when the transmission voltage matrix is an orthogonal matrix, the power supply voltage can efficiently be made smaller. The orthogonal matrix here is a matrix forming a unit matrix as a product of a transposed matrix and itself.

As a matrix that satisfies these conditions, for example, Hadamard matrix is known. The Hadamard matrix is a square matrix in which elements are “1” or “−1” and the respective rows are orthogonal to each other.

As an example of the first transmission voltage matrix, the case where all transmitting electrodes 3 are simultaneously driven by the Hadamard matrix will be explained. Note that, for convenience of explanation, the case of using the Hadamard matrix of 8 rows and 8 columns shown in Formula 9 will be explained, however, not limited to that. Also, note that, in the following examples, the feature will be explained using relatively small matrices for convenience sake, however, not limited to that, either.

$$T = [ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ 1 & - 1 & - 1 & 1 & 1 & - 1 & - 1 & 1 \\ 1 & 1 & 1 & 1 & - 1 & - 1 & - 1 & - 1 \\ 1 & - 1 & 1 & - 1 & - 1 & 1 & - 1 & 1 \\ 1 & 1 & - 1 & - 1 & - 1 & - 1 & 1 & 1 \\ 1 & - 1 & - 1 & 1 & - 1 & 1 & 1 & - 1\end{matrix} ] \\ {T}^{- 1} = \frac{1}{8} \cdot T \qquad Formula 9$$

In this case, compared to the case of the conventional line-sequential driving, the number of driving times is eightfold for the respective electrodes, and, when the driving is performed at the same voltage, the eightfold power consumption is necessary for driving. However, in the inverse matrix of the transmission voltage matrix multiplied in the case where intersection coupling matrix P(n,m) that would flow at line-sequential driving is obtained, the magnitudes of the respective elements become one-eighth. By the one-eighth computation, the magnitude of noise becomes one-eighth. Accordingly, the strength of the combined noise of eight times of driving is obtained by the square-root of sum of squares when the noise is random, and thus, given that the strength of the noise at line-sequential driving is “1”, as shown in Formula 10, it becomes about 0.35-fold. Alternatively, it may be considered that the noise becomes about 0.35-fold by averaging of the eight measurement values. In this manner, in the case of using the orthogonal matrix, the noise can be attenuated in proportion to the reciprocal of the square-root of the number of simultaneously driven transmitting electrodes 3.

$$\begin{matrix}Ratio of Combined Noise = \frac{\sqrt{8 times \times {( \frac{1}{8} fold )}^{2}}}{\sqrt{1 time \times 1 {fold}^{2}}} \\ = \frac{1}{\sqrt{8}} \approx 0.35\end{matrix} \qquad Formula 10$$

Further, in the case of using the same S/N-ratio as that in the case of the conventional line-sequential driving, the strength of the signal is proportional to the voltage of driving, and thus, the power supply voltage can be made as small as about 0.35-fold. Here, since the power consumption necessary for driving is considered to be proportional to the square of the power supply voltage, even when the number of driving times becomes eight-fold, the power consumption can be suppressed to nearly the same. Further, in consideration of the size of a boosting circuit, the boosting power efficiency, the withstand voltage of the drive circuit, or the like, the merit of largely reduced driving voltage is significant. Alternatively, by simultaneously driving the plural transmitting electrodes 3, for example, at driving with the same power supply voltage, the number of cycles of the alternating voltages output from the multiline driving means 5 for driving can be reduced, and the detection speed can be made higher.

Note that, in order to make the phase relation to the periodic noise produced at each driving random, as shown in FIG. 4, random intervals maybe inserted between the respective drivings so that the phase relation of the alternating voltages at each driving may not be constant.

Here, since the Hadamard matrix for simultaneously driving all transmitting electrodes 3 has the size of power of two, the matrix is limited for the case where the number of transmitting electrodes 3 is the power of two. In the example of the second transmission voltage matrix shown in Formula 11 as below, the number of transmitting electrodes 3 is not limited to the power of two, and a larger transmission voltage matrix is formed by inserting small Hadamard matrices in diagonal elements. For example, the case where a 6-row and 6-column transmission voltage matrix is formed by inserting three 2-row and 2-column Hadamard matrices in diagonal elements is shown in Formula 11. Note that, in order to improve the synchronism of detection between electrodes by shortening the period of driving, as shown in Formula 11, the transmission voltage matrix in which rows are rearranged may be used. Further, rearrangement of columns may not particularly be problematic.

$$Matrix before Rearrangement = [ \begin{matrix}1 & 1 & 0 & 0 & 0 & 0 \\ 1 & - 1 & 0 & 0 & 0 & 0 \\ 0 & 0 & 1 & 1 & 0 & 0 \\ 0 & 0 & 1 & - 1 & 0 & 0 \\ 0 & 0 & 0 & 0 & 1 & 1 \\ 0 & 0 & 0 & 0 & 1 & - 1\end{matrix} ] \\ T = [ \begin{matrix}1 & 1 & 0 & 0 & 0 & 0 \\ 0 & 0 & 1 & 1 & 0 & 0 \\ 0 & 0 & 0 & 0 & 1 & 1 \\ 1 & - 1 & 0 & 0 & 0 & 0 \\ 0 & 0 & 1 & - 1 & 0 & 0 \\ 0 & 0 & 0 & 0 & 1 & - 1\end{matrix} ] \\ {T}^{- 1} = \frac{1}{2} \cdot [ \begin{matrix}1 & 0 & 0 & 1 & 0 & 0 \\ 1 & 0 & 0 & - 1 & 0 & 0 \\ 0 & 1 & 0 & 0 & 1 & 0 \\ 0 & 1 & 0 & 0 & - 1 & 0 \\ 0 & 0 & 1 & 0 & 0 & 1 \\ 0 & 0 & 1 & 0 & 0 & - 1\end{matrix} ] = \frac{1}{2} \cdot {T}^{T} \qquad Formula 11$$

In this example, as is the case of the example of the case of Formula 9, while the same S/N-ratio as that of the conventional line-sequential is kept, the power supply voltage can be made smaller to the reciprocal-fold of the square root of two, i.e., about 0.71-fold. The power consumption in this case is nearly the same as that in the case of line-sequential driving. Alternatively, the detection speed may be made similarly higher.

As above, the cases where the Hadamard matrix itself is used and only the Hadamard matrix is used for the submatrix have been shown, and further, the case where an example in which matrices formed by multiplying the respective elements of the 2-row and 2-column Hadamard matrix by “−1” and the right and left columns are exchanged are added to start from the first column in the fourth row, the third column in the sixth row, and the fifth column in the second row is shown in Formula 12.

$$T = [ \begin{matrix}1 & 1 & 1 & - 1 & 0 & 0 \\ 1 & - 1 & 0 & 0 & - 1 & - 1 \\ 0 & 0 & 1 & 1 & 1 & - 1 \\ - 1 & - 1 & 1 & - 1 & 0 & 0 \\ 1 & - 1 & 0 & 0 & 1 & 1 \\ 0 & 0 & - 1 & - 1 & 1 & - 1\end{matrix} ] \\ {T}^{- 1} = \frac{1}{4} \cdot [ \begin{matrix}1 & 1 & 0 & - 1 & 1 & 0 \\ 1 & - 1 & 0 & - 1 & - 1 & 0 \\ 1 & 0 & 1 & 1 & 0 & - 1 \\ - 1 & 0 & 1 & - 1 & 0 & - 1 \\ 0 & - 1 & 1 & 0 & 1 & 1 \\ 0 & - 1 & - 1 & 0 & 1 & - 1\end{matrix} ] = \frac{1}{4} \cdot {T}^{T} \qquad Formula 12$$

In this example, it is unnecessary that the number of transmitting electrodes 3 is the power of two, and four transmitting electrodes 3 are simultaneously driven. Accordingly, the power supply voltage and the detection speed are further improved than in the case of Formula 11.

As another method of obtaining the transmission voltage matrix of not power of two, a larger submatrix of Hadamard matrix may be used. For example, as a 7-row and 7-column transmission voltage matrix, a transmission voltage matrix shown in Formula 13 is obtained as a submatrix formed by removing the first row and the eighth column of an 8-row and 8-column transmission voltage matrix, for example. Note that, in this case, the matrix is not an orthogonal matrix and, even when seven transmitting electrodes 3 are simultaneously driven, only the same effect as that in the case of averaging four times of measurement is obtained. Despite this, compared to the line-sequential driving, the effect of shortening the detection speed to four-fold when the driving is performed at the same voltage, for example, is great. The four times of measurement here corresponds to the four elements not zero in the respective rows of the inverse matrix of T shown by Formula 13 for obtaining the values of the respective elements of the intersection coupling matrix at the linear computation step 22. That is, the transmitting electrodes 3 are driven at seven times and the electrostatic capacitances of the respective intersection couplings are determined by the predetermined four times of measurement of them.

$$T = [ \begin{matrix}1 & - 1 & 1 & - 1 & 1 & - 1 & 1 \\ 1 & 1 & - 1 & - 1 & 1 & 1 & - 1 \\ 1 & - 1 & - 1 & 1 & 1 & - 1 & - 1 \\ 1 & 1 & 1 & 1 & - 1 & - 1 & - 1 \\ 1 & - 1 & 1 & - 1 & - 1 & 1 & - 1 \\ 1 & 1 & - 1 & - 1 & - 1 & - 1 & 1 \\ 1 & - 1 & - 1 & 1 & - 1 & 1 & 1\end{matrix} ] \\ {T}^{- 1} = \frac{1}{4} \cdot [ \begin{matrix}1 & 1 & 0 & 1 & 0 & 0 & 1 \\ 0 & 1 & - 1 & 1 & - 1 & 0 & 0 \\ 1 & 0 & - 1 & 1 & 0 & - 1 & 0 \\ 0 & 0 & 0 & 1 & - 1 & - 1 & 1 \\ 1 & 1 & 0 & 0 & - 1 & - 1 & 0 \\ 0 & 1 & - 1 & 0 & 0 & - 1 & 1 \\ 1 & 0 & - 1 & 0 & - 1 & 0 & 1\end{matrix} ] \qquad Formula 13$$

Note that, in the case of using the Hadamard matrix shown in Formula 9, since the polarities of all transmitting electrodes 3 are the same when the first row is driven, if the finger does not approach, the combined current flowing in the receiving electrodes 4 becomes larger and easier to be saturated in the current measurement means 6. When the absolute value of the total value of the currents applied to the rows of the transmission voltage matrix is large, it is easier to be saturated in the current measurement means 6. In the case of the Hadamard matrix shown in Formula 9, the total value in the first row is “8” and the total values of the other rows are “0”. If the gain of the current measurement means 6 is lowered to avoid the saturation, the resolution of the detection may be reduced or the influence of the noise on the current measurement means 6 may be relatively larger.

Accordingly, to avoid saturation without lowering the gain of the current measurement means 6, by factor multiplication is performed with respect to each column of the transmission voltage matrix T, the reception currents when the finger does not approach are made smaller so that the saturation in the current measurement means 6 may not occur. Further, to equalize the polarities of the total values of the rows, factor multiplication may be performed with respect to each row. For example, using the transmission voltage matrix T in which the second column, the third column, and the fifth row of the Hadamard matrix shown in Formula 9 are multiplied by “−1” shown in Formula 14, the maximum absolute value of the total values of the rows becomes “4”, and the maximum value of the currents of the receiving electrodes 4 when the finger does not approach can be suppressed to about a half of the Hadamard matrix shown in Formula 9. The inverse matrix in this case is obtained by dividing the transposed matrix of the transmission voltage matrix by “8”.

$$T ( t , n ) = [ \begin{matrix}1 & - 1 & - 1 & 1 & 1 & 1 & 1 & 1 \\ 1 & 1 & - 1 & - 1 & 1 & - 1 & 1 & - 1 \\ 1 & - 1 & 1 & - 1 & 1 & 1 & - 1 & - 1 \\ 1 & 1 & 1 & 1 & 1 & - 1 & - 1 & 1 \\ - 1 & 1 & 1 & - 1 & 1 & 1 & 1 & 1 \\ 1 & 1 & - 1 & - 1 & - 1 & 1 & - 1 & 1 \\ 1 & - 1 & 1 & - 1 & - 1 & - 1 & 1 & 1 \\ 1 & 1 & 1 & 1 & - 1 & 1 & 1 & - 1\end{matrix} ] \\ Σ ( t ) = [ \begin{matrix}4 \\ 0 \\ 0 \\ 4 \\ 4 \\ 0 \\ 0 \\ 4\end{matrix} ] \\ {T}^{- 1} = \frac{1}{8} \cdot {T}^{T} \qquad Formula 14$$

Note that, here, the case where the second column, the third column, and the fifth row are multiplied by “−1” is shown, however, not limited to that, but any row or column may be multiplied by “−1” as long as the range of the total values of the rows is small. These factors may be easily obtained by allowing a program to determine that they make the absolute value of the total value of the respective rows small with respect to all combinations of “1” or “−1” of the column factors, for example, and multiplying the rows with the negative total values of the respective rows by “−1”. Alternatively, by focusing attention on the rows with the large absolute value of the total value of the respective rows and changing the column factors to making the values smaller, desirable factors can easily be obtained faster.

Regarding the way to determine the transmission voltage matrix, the cases where the number of transmitting electrodes 3 have been explained for convenience sake by taking the examples, however, it is obvious that the transmission voltage matrix can be determined in the same way even when the number of transmitting electrodes 3 becomes larger.

Further, the transmission voltage matrix T and its inverse matrix have been explained, however, the matrix V indicating the voltage changes and its inverse matrix may be the same.

Note that the transmission voltage matrix, the reception current matrix, and the intersection coupling matrix that have been explained are abstract representation for convenience sake, and it is obvious that the matrices are specifically realized by plural memory devices or computing means.

As shown above, according to the invention, by simultaneously driving the plural transmitting electrodes 3, the power supply voltage can be reduced without lowering the S/N-ratio, or a proximity detection device and method having a high detection speed can be realized. Alternatively, by making the frequency of the alternating voltage lower, a proximity detection device and method that can successfully perform detection even when wiring resistance is high can be realized. Or, when the power supply voltage, the detection speed, and the frequencies of the alternating voltages are the same, a proximity detection device and method that can make the influence of noise smaller can be realized.

1. A proximity detection device of obtaining an approach determination or an approach position of an object, characterized by comprising:
plural transmitting electrodes corresponding to one dimension in a detection area on supporting means and receiving electrodes corresponding to the other dimension;
multiline driving means for simultaneously applying periodic alternating voltages to at least two electrodes of the transmitting electrodes;
current measurement means for measuring currents or amounts of charge from the receiving electrodes in synchronization with driving to the transmitting electrodes;
computing means for obtaining the approach determination or the approach position of the object toward the detection area by converting current values or amounts of charge measured in the current measurement means into values in response to electrostatic capacitances of respective intersections between the transmitting electrodes and the receiving electrodes; and
control means for managing statuses and sequences of the multiline driving means, the current measurement means, and the computing means.

2. The proximity detection device according to claim 1, wherein the computing means includes:
linear computing means for performing linear computation to convert the current values or amounts of charge measured in the current measurement means into values in response to the electrostatic capacitances of the respective intersections between the transmitting electrodes and the receiving electrodes; and
proximity computing means for obtaining the approach determination or the approach position of the object toward the detection area from an output of the linear computing means.

3. The proximity detection device according to claim 1, wherein the alternating voltages sequentially applied by the multiline driving means to the plural transmitting electrodes correspond to a transmission voltage matrix, and the transmission voltage matrix is a regular matrix.

4. The proximity detection device according to claim 3, wherein the transmission voltage matrix is an orthogonal matrix.

5.-7. (canceled)

8. The proximity detection device according to claim 1, wherein the multiline driving means has delay time adjustment means for generating delays to eliminate variations in delay times produced in the receiving electrodes.

9. The proximity detection device according to claim 1, wherein control means of the proximity detection device has power-save mode switching means for switching between a mode in which the multiline driving means drives at least in the number of times smaller than the number of the transmitting electrodes and a mode in which the multiline driving means drives in the number of times equal to or larger than the number of electrodes of the transmitting electrodes.

10. The proximity detection device according to claim 1, wherein the control means has interval generating means for providing arbitrary intervals between plural times of measurement of the currents corresponding to the transmitting electrodes when the multiline driving means drives the transmitting electrodes at plural times.

11. A proximity detection method of obtaining an approach determination or an approach position of an object, characterized by comprising:
a driving and measurement step of simultaneously applying periodic alternating voltages to plural transmitting electrodes corresponding to one dimension in a detection area for detection of the approach of the object and measuring currents or amounts of charge from receiving electrodes corresponding to the other dimension in synchronization with driving to the transmitting electrodes; and
a computation step of obtaining the approach determination or the approach position of the object toward the detection area by converting current values or amounts of charge obtained at the driving and measurement step into values in response to electrostatic capacitances of respective intersections between the transmitting electrodes and the receiving electrodes.

12. The proximity detection method according to claim 11, wherein the computation step includes:
a linear computation step of performing linear computation to convert the current values or amounts of charge measured at the driving and measurement step into values in response to the electrostatic capacitances of the respective intersections between the transmitting electrodes and the receiving electrodes; and
a proximity computation step of obtaining the approach determination or the approach position of the object toward the detection area from an output at the linear computation step.

13. The proximity detection method according to claim 11, wherein the alternating voltages are sequentially applied to the plural transmitting electrodes, the alternating voltages correspond to a transmission voltage matrix, and the transmission voltage matrix is a regular matrix.

14. The proximity detection method according to claim 13, wherein the transmission voltage matrix is an orthogonal matrix.

15.-20. (canceled)

21. The proximity detection method according to claim 11, wherein the driving and measurement step has a delay time adjustment step of generating delays to eliminate variations in delay times produced in the receiving electrodes.

22. The proximity detection method according to claim 11, wherein the driving and measurement step switches between a mode in which the transmitting electrodes are driven at the number of times smaller than the number of transmitting electrodes and a mode in which the transmitting electrodes are driven at the number of times equal to or larger than the number of transmitting electrodes.

23. The proximity detection method according to claim 11, wherein the driving and measurement step provides arbitrary intervals between plural times of measurement of the currents corresponding to the transmitting electrodes when the driving and measurement step drives the transmitting electrodes at plural times.
